(19) United States
(12) Patent Application Publication
(10) Pub. No.: US 2016/0243517 A1
(43) Pub. Date: Aug. 25, 2016

(54) METHOD OF MANUFACTURING DISPERSION LIQUID AND MANUFACTURING APPARATUS OF DISPERSION LIQUID

(71) Applicant: Seiko Epson Corporation, Tokyo (JP)

(72) Inventors: Kenji KITADA, Shiojiri-shi (JP); Maki NARIAI, Shiojiri-shi (JP); Atsushi DENDA, Chino-shi (JP); Naoyuki TOYODA, Suwa-shi (JP)

(73) Assignee: Seiko Epson Corporation, Tokyo (JP)

(21) Appl. No.: 15/051,351

(22) Filed: Feb. 23, 2016

(30) Foreign Application Priority Data
Feb. 24, 2015 (JP) 2015-033591

(51) Int. Cl. B01J 13/06; B01J 19/10

(52) U.S. Cl. CPC B01J 13/06; B01J 19/10; B01J 2219/0894; B01J 2219/0877

(57) ABSTRACT

A method of manufacturing a dispersion liquid includes preparing a mixed liquid which contains a first solvent, a second solvent having solubility which is equal to or less than 1% with respect to the first solvent, and a compound having a polymerizable functional group; and microcapsulating and dispersing the first solvent or the second solvent by performing liquid plasma treatment on the mixed liquid while applying ultrasonic waves to the mixed liquid by using an ultrasonic wave generating apparatus.

### BACKGROUND

1. Technical Field

The present invention relates to a method of manufacturing a dispersion liquid and a manufacturing apparatus of a dispersion liquid.

2. Related Art

In recent years, studies regarding the improvement of a surface state of a material by using plasma have been actively conducted. It is known that when a target material is irradiated with plasma, ionized molecules of the plasma (for example, a hydroxy group) are modified on the surface, and thereby wettability with respect to water is improved.

As a technique of using such plasma, a liquid surface plasma technique which generates plasma in the vicinity of the liquid surface has been known (for example, refer to JP-A-2013-34914). JP-A-2013-34914 discloses a technique of improving a dispersion effect of a dispersoid through liquid surface plasma treatment performed in such a manner that one of a pair of electrodes is dipped into a liquid or comes in contact with a liquid surface, and the other one is disposed in the air above the liquid surface, and then a voltage is applied between the electrodes so as to generate the plasma, and through mechanical dispersion treatment (treatment of shearing and stirring particles).

In the technique disclosed in JP-A-2013-34914, in a case where a dispersoid is in a solid state, a new interface is formed by crushing the dispersoid in the liquid through the mechanical dispersion treatment, then the aforementioned interface is subjected to the plasma treatment, and thereby it is possible to improve a dispersion effect of a dispersoid. However, in a case where the dispersoid is in a liquid state, even when a new interface is formed through the mechanical dispersion treatment, the interface has fluidity, and thus it is difficult to obtain an effect through the plasma treatment, which results in a problem.

### SUMMARY

In this regards, an advantage of some aspects of the invention is to provide a method of manufacturing a dispersion liquid and a manufacturing apparatus of a dispersion liquid which are capable of obtaining a dispersion liquid excellent in the dispersion stability in a liquid-liquid dispersion system.

The invention can be realized in the following aspects or application examples.

### Application Example 1

According to an aspect of the invention, there is provided a method of manufacturing a dispersion liquid including preparing a mixed liquid which contains a first solvent, a second solvent having solubility which is equal to or less than 1% with respect to the first solvent, and a compound having a polymerizable functional group; and microcapsulating and dispersing the first solvent or the second solvent by performing liquid plasma treatment on the mixed liquid while applying ultrasonic waves to the mixed liquid by using an ultrasonic wave generating apparatus.

According to the method of manufacturing a dispersion liquid in Application Example 1, since the mixed liquid is irradiated with the ultrasonic waves, it is possible to obtain a liquid-liquid dispersion system in which any one of the first solvent and the second solvent is a dispersoid, and it is possible to microcapsulate the dispersoid on the interface between the first solvent and the second solvent in the liquid-liquid dispersion system by forming a polymer formed of radical which is generated by the cavitation of the ultrasonic waves with the compound having a polymerizable functional group. Further, the liquid plasma treatment is performed while applying the ultrasonic waves to the mixed liquid, and thus it is possible to perform the plasma treatment on the microcapsule. In addition, it is possible to prompt the generation of the plasma by using the bubbles caused by the cavitation generated due to the ultrasonic irradiation. For this reason, it is possible to improve the dispersion treatment efficiency of the liquid-liquid dispersion system, and to prevent aggregation and sedimentation of the dispersoid in the liquid-liquid dispersion system for a long period of time, thereby improving the dispersion stability.

### Application Example 2

In the method of manufacturing a dispersion liquid according to Application Example 1, an oscillation frequency of the ultrasonic wave generating apparatus may be in a range of 10 kHz to 1000 kHz.

According to the method of manufacturing a dispersion liquid in Application Example 2, a sufficient amount of ultrasonic wave energy can be obtained, and thus it is possible to induce polymerization reaction of the compound having a polymerizable functional group on the interface between the first solvent and the second solvent in the liquid-liquid dispersion system. In addition, it is possible to generate the plasma in bubbles caused by the cavitation generated due to the ultrasonic irradiation. For this reason, it is possible to improve the efficiency of plasma generation, and as a result it is possible to further improve the dispersion treatment efficiency.

### Application Example 3

In the method of manufacturing a dispersion liquid according to any one of Application Example 1 or 2, the polymerizable functional group may be at least one selected from the group consisting of a (meth)acryloyl group, a vinyl group, a vinyl ether group, and a mercapto group.

According to the method of manufacturing a dispersion liquid in Application Example 3, it is possible to microcapsulate the dispersoid by performing radical polymerization reaction with the compound having a polymerizable functional group on the interface between the first solvent and the second solvent in the liquid-liquid dispersion system.

### Application Example 4

In the method of manufacturing a dispersion liquid according to any one of Application Examples 1 to 3, the compound having a polymerizable functional group may be a material having amphiphilicity.

According to the method of manufacturing a dispersion liquid in Application Example 4, the compound having a polymerizable functional group is easily localized on the interface between the first solvent and the second solvent in a liquid-liquid dispersion system, and thus a microcapsule coating film is easily formed on the interface between the first solvent and the second solvent.

### Application Example 5

In the method of manufacturing a dispersion liquid according to any one of Application Examples 1 to 4, the mixed liquid may further include a solid material which is dissolved in any one of the first solvent and the second solvent.

According to the method of manufacturing a dispersion liquid in Application Example 5, it is possible to dissolve the solid material in any one of the first solvent and the second solvent which is capsulated in the microcapsule. With this, it is possible to impart various additional values to the obtained dispersion liquid.

### Application Example 6

In the method of manufacturing a dispersion liquid according to any one of Application Examples 1 to 5, a content of the compound having a polymerizable functional group in the mixed liquid may be in a range of 0.01 mass % to 50 mass %.

According to the method of manufacturing a dispersion liquid in Application Example 6, it is possible to prevent over-dispersion by properly setting the number and particle sizes of the microcapsules which are formed on the interface between the first solvent and the second solvent in the liquid-liquid dispersion system, and thereby the dispersion stability is further improved.

### Application Example 7

According to another aspect of the invention, there is provided a manufacturing apparatus of a dispersion liquid including a storage tank into which a mixed liquid containing a first solvent, a second solvent having solubility which is equal to or less than 1% with respect to the first solvent, and a compound having a polymerizable functional group is put; an ultrasonic wave generating mechanism that applies ultrasonic waves to the mixed liquid which is put into the storage tank; and a liquid plasma treatment mechanism that performs plasma treatment on the mixed liquid which is put into the storage tank, in which a microcapsule which is obtained by the ultrasonic irradiation in the mixed liquid is dispersed in the mixed liquid by performing the liquid plasma treatment with respect to the microcapsule by using the liquid plasma treatment mechanism.

According to the manufacturing apparatus of a dispersion liquid in Application Example 7, the ultrasonic treatment and the plasma treatment in the liquid-liquid dispersion system are performed in the liquid almost at the same time, and thus it is possible to perform the plasma treatment with respect to the microcapsule formed on the interface between the first solvent and the second solvent. In addition, it is possible to prompt the generation of the plasma by using the bubbles caused by the cavitation generated in the ultrasonic wave generating mechanism. With such a configuration, the dispersion treatment efficiency in the liquid-liquid dispersion system is improved. Further, it is possible to prevent aggregation and sedimentation of the dispersoid in the liquid-liquid dispersion system for a long period of time, and to improve the dispersion stability.

### BRIEF DESCRIPTION OF THE DRAWINGS

The invention will be described with reference to the accompanying drawings, wherein like numbers reference like elements.

FIG. 1 is a schematic view of a manufacturing apparatus of a dispersion liquid according to a first embodiment.

FIG. 2 is a schematic view of a manufacturing apparatus of a dispersion liquid according to a second embodiment.

### DESCRIPTION OF EXEMPLARY EMBODIMENTS

Hereinafter, the preferred embodiments of the invention will be described. The embodiments described below are intended to describe examples of the invention. In addition, the invention is not limited to the following embodiments, but includes various modification examples employed in the scope without changing the gist of the invention. Note that, not all of the configurations described below are the essential configuration of the present invention.

The term “liquid plasma” which is used in the invention represents low-temperature non-equilibrium plasma in a liquid, and more specifically represents plasma which is generated in bubbles by adding a voltage between the pair of electrodes which are dipped into the dispersion medium while generating bubbles in the dispersion medium in a state where a pair of electrodes are dipped into a dispersion medium or come in contact with a liquid surface of the dispersion medium.

The term “microcapsule” which is used in the invention referred to as a capsule having a median size in a range of 0.01 μm to 1000 μm.

Hereinafter, a manufacturing apparatus of a dispersion liquid, a method of manufacturing a dispersion liquid, and a dispersion liquid which is manufactured through this manufacturing method are sequentially described.

### 1. MANUFACTURING APPARATUS OF DISPERSION LIQUID

A manufacturing apparatus of a dispersion liquid according to the embodiment is provided with a storage tank into which a mixed liquid contains a first solvent, a second solvent having solubility which is equal to or less than 1% with respect to the first solvent, and a compound having a polymerizable functional group is put; an ultrasonic wave generating mechanism that applies ultrasonic waves to the mixed liquid which is input to the storage tank; and a liquid plasma treatment mechanism that performs plasma treatment on the mixed liquid which is put into the storage tank, a microcapsule is dispersed in the mixed liquid by performing the liquid plasma treatment with respect to the microcapsule which is obtained by the ultrasonic irradiation in the mixed liquid by using the liquid plasma treatment mechanism. Hereinafter, the manufacturing apparatus of a dispersion liquid according to the embodiment will be described with reference to the drawings.

### 1.1. Configuration of Apparatus of First Embodiment

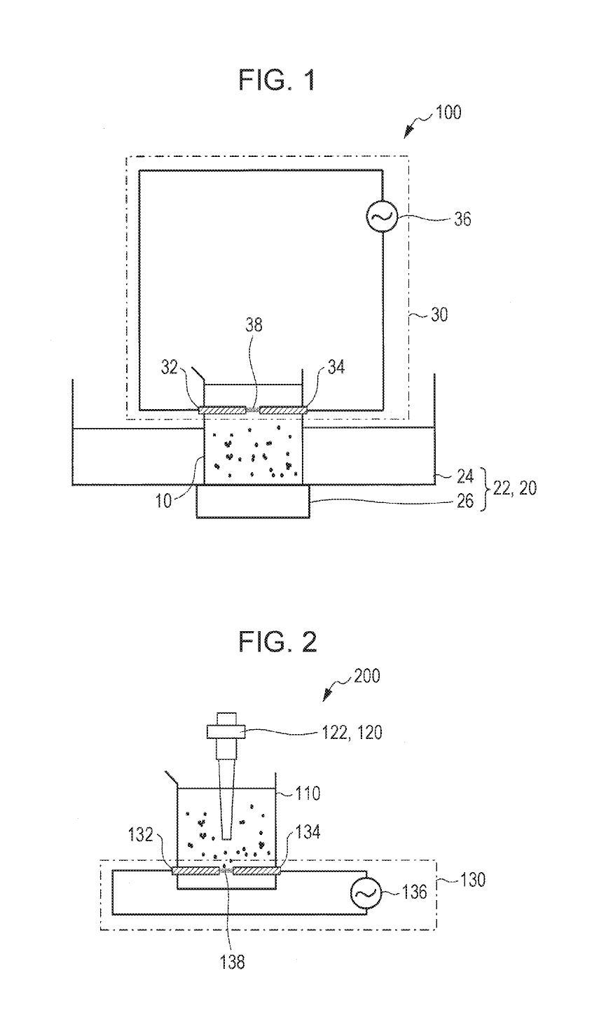

FIG. 1 is a schematic view of a manufacturing apparatus of a dispersion liquid according to a first embodiment. A manufacturing apparatus 100 is provided with a storage tank 10 to which a mixed liquid is input, an ultrasonic wave generating mechanism 20 that applies ultrasonic waves to the mixed liquid which is input to the storage tank 10, and a liquid plasma treatment mechanism 30 that performs plasma treatment on the mixed liquid which is input to the storage tank 10.

A material of the storage tank 10 is not particularly limited as long as the material can hold the mixed liquid before and after generating the plasma; however, examples thereof include materials such as glass, resin, and metal. When the material such as glass or resin which has transparency in visible light is selected as the material of the storage tank 10, it is possible to observe a state of dispersion from the outside of the storage tank 10 and thus glass or resin is preferably used. In addition, it is possible to evaluate the dispersion state by measuring the particle size distribution of the turbidity or light scattering by using a device. Examples of the material having the transparency include glass, a polyethylene terephthalate resin, a vinyl chloride resin, an acrylic resin, and polycarbonate. A shape of the storage tank 10 is not particularly limited as long as the electrode 32 and the electrode 34 of the liquid plasma treatment mechanism 30 can be inserted and fixed into the storage tank 10. The storage tank 10 is disposed so as to be dipped into water which is put into a washing tank 24 of an ultrasonic washing machine 22, both of which are described below.

In the first embodiment, the ultrasonic wave generating mechanism 20 is formed of the ultrasonic washing machine 22. The ultrasonic washing machine 22 is provided with the washing tank 24 and an ultrasonic wave generating unit 26. In an example illustrated in FIG. 1, the ultrasonic wave generating unit 26 is attached on only the outside of a bottom surface of the washing tank 24; however, the invention is not limited thereto. For example, the ultrasonic wave generating unit 26 may be attached on the outside of a side surface of the washing tank 24. In addition, a configuration such that an ultrasonic vibrator such as a disc-type vibrator or a spherical type vibrator is directly disposed in the washing tank 24 or the storage tank 10 may be employed. With cavitation caused by the ultrasonic washing machine 22, it is possible to prepare a liquid-liquid dispersion system in which any one of the first solvent and the second solvent becomes a dispersoid. Typically, of the first solvent and the second solvent, the solvent having less capacity becomes a dispersoid and the solvent having more capacity becomes a dispersion medium. Further, when the energy which is generated by the ultrasonic waves is applied to the compound having a polymerizable functional group which exists on an interface between the first solvent and the second solvent in the liquid-liquid dispersion system, polymerization reaction occurs, and thus it is possible to form a microcapsule coating film. Note that, it is necessary that water for generating the cavitation is put into the washing tank 24.

In normal water, an amount of energy required to generate the cavitation is differentiated depending on a frequency. That is, when the frequency is low, it is possible to generate the cavitation with a less amount of energy; however, the energy amount is affected by amplitude and vibration frequency, and thus when the frequency is very low, more amplitude is required. For this reason, in consideration of a balance between a generation amount of the cavitation and a required energy amount, an oscillation frequency of the ultrasonic washing machine 22 is preferably in a range of 10 kHz to 1000 kHz, and is preferably in a range of 20 kHz to 500 kHz. In the ultrasonic washing machine 22, a parameter of a circuit element such as a resistor, a capacitor, or a coil which constitute an oscillation circuit may be adjusted such that the oscillation frequency and a phase of a vibrating element in the ultrasonic wave generating unit 26 (not shown) can be separately adjusted.

Examples of such an ultrasonic washing machine include Model Nos. “W-113”, “W-357-07HPD”, and “W-357HPD” manufactured by Honda Electronics Co., Ltd.; and BRANSONIC series manufactured by Branson Ultrasonics Corporation.

The liquid plasma treatment mechanism 30 is provided with a pair of electrode 32 and the electrode 34 which are disposed in a state of being dipped into a mixed liquid which is put into the storage tank 10 or coming in contact with a liquid surface of the mixed liquid, and a power source 36. In addition, although not shown, a gas storage unit and a gas inlet tube for introducing a gas into a plasma generation unit 38 between the electrode 32 and the electrode 34 may be provided therein.

Examples of tip end portions of the electrode 32 and the electrode 34 include a needle shape, a hollow needle shape, a cylindrical shape, a spherical shape, a hemispherical shape, a linear shape, and a flat shape; however, the needle shape in which the plasma is easily generated even at a low voltage is preferably used. The tip end portions of the electrode 32 and the electrode 34 are not necessarily adjacent to each other, but may have a difference in level therebetween to the extent that the liquid plasma can be generated.

Materials for the electrode 32 and electrode 34 are not particularly limited, as long as the material has conductivity; however, examples thereof include copper, tungsten, copper tungsten, graphite, titanium, stainless steel, molybdenum, aluminum, iron, nickel, platinum, and gold.

Examples of the power source 36 which is used to generate the liquid plasma include a DC power source, a pulse power source, a low frequency and high frequency AC power source, and a microwave power source. Among them, it is preferable to use the power source which is capable of outputting AC frequency which is equal to or lower than 30 kHz such that the plasma is stably generated at a low temperature.

A generating mechanism of the liquid plasma in the liquid plasma treatment mechanism 30 is as follows. In the plasma generation unit 38, when a pulse voltage is applied between the electrode 32 and the electrode 34, localized Joule heat is generated by the applied pulse voltage, the dispersion medium and dissolved oxygen is vaporized in the electrode 32 and the electrode 34, and bubbles with a micrometer size or less are generated in the mixed liquid. In addition, when a space between the electrode 32 and the electrode 34 is filled with bubbles with constant density, dielectric breakdown occurs, and thereby the plasma is generated in the bubbles. In accordance with the generation of the plasma, current is sharply increased, and the voltage is decreased while the power is maintained.

In the manufacturing apparatus 100 according to the first embodiment, the cavitation is generated by the ultrasonic washing machine 22, and the generated cavitation can cause the plasma in the bubbles. With this, the efficiency of plasma generation is improved, and it is possible to efficiently improve the dispersion treatment.

As described above, it is possible to discharge electricity while introducing a certain type of gas to the plasma generation unit 38 from the gas inlet tube which is connected to gas storage unit. Examples of a raw material of such a gas include oxygen (O₂), nitrogen (N₂), air (including at least nitrogen (N₂) and oxygen (O₂)), vapor (H₂O), nitrous oxide (N₂O), ammonia (NH₃), argon (Ar), helium (He), and neon (Ne). The gases may be used alone or in combination of two or more types thereof.

In order to enhance the stability of the liquid plasma, a diameter of the electrode 32 and the electrode 34 is preferably equal to or less than 1 mm, and is more preferably in a range of 0.2 mm to 1 mm. In addition, in order to enhance the stability of the liquid plasma, a distance between the electrode 32 and the electrode 34 (distance between electrodes) is preferably in a range of 0.001 mm to 100 mm, and is more preferably in a range of 0.1 mm to 30 mm. Further, in consideration of safety and electrode wear, the voltage to be applied is preferably greater than 0 kV and equal to or lower than 30 kV, and is more preferably in a range of 1 kV to 10 kV such that a constant voltage can be applied.

With the manufacturing apparatus of a dispersion liquid according to the first embodiment, the ultrasonic treatment and the plasma treatment in the liquid-liquid dispersion system are performed almost at the same time, and thus it is possible to perform the plasma treatment with respect to the microcapsule formed the interface between the first solvent and the second solvent. In addition, it is possible to prompt the generation of the plasma by using the bubbles caused by the cavitation generated in the ultrasonic wave generating mechanism. With such a configuration, the dispersion treatment efficiency in the liquid-liquid dispersion system is improved. Further, it is possible to prevent aggregation and sedimentation of the dispersoid in the liquid-liquid dispersion system for a long period of time, and to manufacture a dispersion liquid which is excellent in the dispersion stability.

### 1.2. Configuration of Apparatus of Second Embodiment

FIG. 2 is a schematic view of a manufacturing apparatus of a dispersion liquid according to a second embodiment. A manufacturing apparatus 200 is provided with a storage tank 110 into which a mixed liquid containing a first solvent, a second solvent having solubility which is equal to or less than 1% with respect to the first solvent, and a compound having a polymerizable functional group is put; an ultrasonic wave generating mechanism 120 that applies ultrasonic waves to the mixed liquid which is put into the storage tank 110; and a liquid plasma treatment mechanism 130 that performs plasma treatment on the mixed liquid which is put into the storage tank 110.

In the manufacturing apparatus 200 according to the second embodiment, a basic configuration of the storage tank 110 is the same as that of the manufacturing apparatus 100 according to the first embodiment. In addition, the liquid plasma treatment mechanism 130 has the same basic configuration as that of the manufacturing apparatus 100 according to the first embodiment, and is provided with an electrode 132, an electrode 134, and a power source 136.

In the second embodiment, the ultrasonic wave generating mechanism 120 is formed of an ultrasonic homogenizer 122. The ultrasonic homogenizer 122 is formed of an oscillator, a converter, and a horn which are not shown in the drawings. The ultrasonic homogenizer 122 is disposed so as to be dipped into the mixed liquid from an opening portion of the storage tank 110. For this reason, the electrode 132 and the electrode 134 in the liquid plasma treatment mechanism 130 are positioned on the lower side as compared with the case in the first embodiment. When the cavitation is generated in the mixed liquid, which is put into the storage tank 110 through the horn, by the ultrasonic waves, it is possible to prepare the liquid-liquid dispersion system and to allow the compound having a polymerizable functional group which exists on the interface between the first solvent and the second solvent to be polymerized and then microcapsulated. It is considered that volume of the ultrasonic irradiation target is small compared with the ultrasonic washing machine 22, and thus the ultrasonic homogenizer 122 has excellent energy efficiency and generation efficiency of the cavitation.

Examples of such an ultrasonic homogenizer include Model Nos. “S-250D” and “SLPe40” manufactured by Branson Ultrasonics Corporation.

### 2. MANUFACTURING METHOD OF DISPERSION LIQUID

A method of manufacturing a dispersion liquid according to the embodiment is performed by preparing a mixed liquid which contains a first solvent, a second solvent having solubility which is equal to or less than 1% with respect to the first solvent, and a compound having a polymerizable functional group, and microcapsulating and dispersing the first solvent or the second solvent by performing liquid plasma treatment on the mixed liquid while applying ultrasonic waves to the mixed liquid by using an ultrasonic wave generating apparatus. The method of manufacturing a dispersion liquid can be easily performed by using, for example, the above-described manufacturing apparatus according to the first embodiment or the manufacturing apparatus according to the second embodiment. Hereinafter, each step will be described in detail.

### 2.1. Preparing Step of Mixed Liquid

First, the mixed liquid which contains the first solvent, the second solvent having solubility which is equal to or less than 1% with respect to the first solvent, and the compound having a polymerizable functional group is prepared.

The first solvent and the second solvent in the mixed liquid may have a relationship such that the solubility of the second solvent is equal to or less than 1% with respect to the first solvent (solubility of the first solvent is equal to or less than 1% with respect to the second solvent). That is, the first solvent and the second solvent are two types of liquids which are not uniformly dissolved with each other (are not optionally mixed), and thus it is necessary to select a solvent which can form a liquid-liquid dispersion system in which one of the first solvent and the second solvent is a dispersion medium, and the other one is a dispersoid.

For example, when an aqueous medium is selected as the first solvent, it is possible to select a non-aqueous medium as the second solvent. Each of the first solvent and the second solvent may be a mixture of two or more materials.

Examples of the aqueous medium include water and a mixture of water and an aqueous organic solvent (alcohols such as ethanol, and n-propanol; polyhydric alcohols such as diethylene glycol and glycerin; and a pyrrolidone-based solvent such as 2-pyrrolidone). The surface tension of the aqueous medium may be adjusted by mixing water with the aqueous organic solvent at a certain ratio.

Examples of the non-aqueous medium include an aliphatic hydrocarbon such as n-hexane, n-octane, n-decane, n-dodecane, n-tetradecane, and n-hexadecane; an alicyclic hydrocarbon such as cyclopentane, cyclohexane, and cyclooctane; an aromatic hydrocarbon such as benzene, toluene, and xylene; a higher fatty acid such as a lauric acid, a myristic acid, a palmitic acid, a stearic acid, an oleic acid, a linoleic acid, and a linolenic acid; oil and fat such as palmitic acid ester, stearic acid ester, oleic acid ester, linoleic acid ester, and linolenic acid ester.

In addition, a fluorine-based medium can be selected as the first solvent or the second solvent. Examples of the fluorine-based medium include hydrofluoroether and perfluorocarbon. For example, when the fluorine-based medium is selected as the first solvent, it is possible to select any one of the above-described aqueous medium and non-aqueous medium as the second solvent.

In addition, when a solid material which is dissolved in any solvent (the first solvent or the second solvent) wrapped by the microcapsule is further added into the mixed liquid which is used in the method of manufacturing a dispersion liquid according to the embodiment, it is possible to dissolve the solid material in the solvent in the microcapsule. With this, it is possible to impart various additional values to the obtained liquid-liquid dispersion system. For example, an application of a drug delivery system is possible in such a manner that a pharmaceutical is dissolved in the non-aqueous medium and capsulated in the microcapsule, and then the microcapsule is broken in an affected part of a patient.

In order to enhance the dispersion stability of the liquid-liquid dispersion system, it is possible to add a surfactant (emulsifier) to the mixed liquid. However, according to the method of manufacturing a dispersion liquid of the embodiment, there is a great advantage in that it is possible to improve dispersion stability by performing the plasma treatment on the surface of the microcapsule without adding a surfactant, and to manufacture an excellent liquid-liquid dispersion system. The surfactant obviously contributes to the dispersion stability of the liquid-liquid dispersion system; however, in a case where the liquid-liquid dispersion system is applied to a coating material, ink, a writing tool, paper, plastic, cloth, a building material, an electrical product, an electronic material, a pharmaceutical, a cosmetic, and ceramic, the surfactant may inhibit the function of the liquid-liquid dispersion system. Therefore, it is preferable that the surfactant is not added to the mixed liquid.

It is preferable that the content ratio between the first solvent and the second solvent in the mixed liquid is set such that the second solvent is in a range of 0.01 part by mass to 100 part by mass with respect to 1 part by mass of the first solvent. In the mixed liquid, if the content of the first solvent is greater than the content of the second solvent, generally, the second solvent is the dispersoid, and the first solvent is the dispersion medium. In contrast, if the content of the second solvent is greater than the content of the first solvent, generally, the first solvent is the dispersoid and the second solvent is the dispersion medium.

The compound having a polymerizable functional group is a material used to form a film of a polymer on the interface between the first solvent and the second solvent. For this reason, it is preferable that the compound having a polymerizable functional group has amphiphilicity. When the compound having a polymerizable functional group has the amphiphilicity, it is likely that the compound exists on the interface between the dispersoid and the dispersion medium, and is microcapsulated. Note that, the “amphiphilicity” in the invention refers to a property which is familiar with both the first solvent and the second solvent. More specifically, the compound having the amphiphilicity refers to a compound which can be dissolved more than 1% with respect to both the first solvent and the second solvent.

The polymerizable functional group of the compound having a polymerizable functional group is not particularly limited; however, examples thereof include a (meth)acryloyl group, a vinyl group, a vinyl ether group, a mercapto group, a urethane group, an epoxy group, and an oxetanyl group. Among them, from a view point that a polymer is formed of radical which is generated by the cavitation of the ultrasonic waves, a (meth)acryloyl group, a vinyl group, a vinyl ether group, and a mercapto group are preferably used. Meanwhile, the above-described manufacturing apparatus of the dispersion liquid is provided with the ultrasonic wave generating mechanism, and thus there is an advantage in that it is not necessary to use a polymerization initiator when the polymer can be formed of radical which is generated by the cavitation of the ultrasonic waves.

Specific examples of the compound having a polymerizable functional group include a (meth)acrylic acid, (meth)acrylic acid ester, bovine serum albumin, styrene, and a styrene derivative. Among them, in terms of the amphiphilicity, a (meth)acrylic acid, (meth)acrylic acid ester, and bovine serum albumin are preferably used, and a (meth)acrylic acid is preferably used.

The content of the compound having a polymerizable functional group in the mixed liquid is preferably in a range of 0.01 mass % to 50 mass %, is more preferably in a range of 0.05 mass % to 20 mass %, and is particularly preferably in a range of 0.1 mass % to 10 mass %. If the content of the compound having a polymerizable functional group is within the above range, the number of the microcapsules and particle sizes are properly set, and the dispersion stability is further enhanced.

An amount of the dissolved oxygen in the first solvent and the second solvent may affect the dispersion stability of the microcapsulated dispersoid. If the amount of the dissolved oxygen is large, it is likely that an oxygen functional group is imparted by the liquid plasma treatment, and thus the dispersion treatment efficiency and dispersion stability are further improved. In addition, in a case where the aqueous medium is set to be dispersion medium, when the amount of the dissolved oxygen in the dispersion medium is large, an oxygen-derived plasma source can be also used in addition to a water-derived plasma source, and thus a surface of the dispersoid is advantageously hydroxylated.

### 2.2. Ultrasonic Treatment Step and Liquid Plasma Treatment Step

A step of crushing the dispersoid is not included in the liquid plasma treatment. Therefore, only with the liquid plasma treatment, when a particle size is large, the dispersoid is sedimented. In addition, even though the dispersoid is subjected to the ultrasonic treatment after being subjected to the liquid plasma treatment, a new liquid-liquid dispersion system is formed and an interface thereof has fluidity, and thus it is likely that a surface on which the plasma treatment is not performed is generated. On the other hand, in a case where the ultrasonic treatment is performed before the liquid plasma treatment, the dispersoid is microcapsulated on an interface of a newly formed liquid-liquid dispersion system. In this case, however, the dispersoid is gradually aggregated over time, and the particle size thereof becomes larger, which results in the sedimentation of the dispersoid.

From the above reasons, in this step, by concurrently performing the ultrasonic treatment and the liquid plasma treatment on the mixed liquid which is obtained from the above, it is possible to obtain the liquid-liquid dispersion system in which any one of the first solvent and the second solvent is the dispersoid, and it is possible to microcapsulate the compound having a polymerizable functional group on the interface between the first solvent and the second solvent in the liquid-liquid dispersion system by forming a polymer formed of radical which is generated by the cavitation of the ultrasonic waves. Then, it is possible to perform the plasma treatment on the obtained microcapsule. In addition, it is possible to prompt the generation of the plasma by using the bubbles caused by the cavitation generated due to the ultrasonic irradiation. For this reason, it is possible to improve the dispersion treatment efficiency of the liquid-liquid dispersion system, and to prevent aggregation and sedimentation of the dispersoid in the liquid-liquid dispersion system for a long period of time, thereby improving the dispersion stability.

The phrase “by concurrently performing the ultrasonic treatment and the liquid plasma treatment” in the invention is not limited to a case where the ultrasonic treatment and liquid plasma treatment are performed completely at the same time. In the invention, examples of a case where the above two types of treatments are performed substantially at the same time include the following cases (a) to (c). (a) The ultrasonic treatment and the liquid plasma treatment are started at the same time, are continuously performed for a predetermined period of time, and then completed at the same time. (b) The ultrasonic treatment and the liquid plasma treatment are sequentially or alternately performed to some extent in a short cycle. (c) The ultrasonic treatment is started first, the liquid plasma treatment is started in the middle of the ultrasonic treatment (at this time, the ultrasonic treatment is continuously performed), the two treatments are continuously performed for a predetermined period of time, then the ultrasonic treatment is completed first, and after a little while, the liquid plasma treatment is completed.

In the step, volume of the storage tank is preferably equal to or greater than 10 mL and less than 100 mL, and is preferably in a range of 10 mL to 50 mL with respect to a pair of electrodes for liquid plasma irradiation. When the volume of the storage tank is within the above range, it is possible to prevent heat generation and over-dispersion through the ultrasonic treatment, and the dispersion treatment efficiency and the dispersion stability are improved. In addition, it is possible to improve treatment capability by using the storage tank which is provided with a mechanism in which the mixed liquid is possibly circulated, or an apparatus which is capable of performing crushing treatment with respect to a plurality of electrodes for the liquid plasma irradiation and a large amount of the mixed liquids.

The oscillation frequency in the ultrasonic treatment step is preferably in a range of 10 kHz to 1000 kHz, and is more preferably 20 kHz to 500 kHz. The oscillation frequency affects the generation amount of the cavitation. That is, when the frequency is low, it is possible to generate the cavitation with a less amount of energy; however, the energy amount is affected by amplitude and vibration frequency, and thus when the frequency is very low, more amplitude is required. For this reason, in the ultrasonic treatment step, the oscillation frequency is preferably in the above range.

An ultrasonic treatment time in the ultrasonic treatment step is preferably in a range of 0.01 minutes to 60 minutes, and is more preferably in a range of 1 minute to 20 minutes. When the ultrasonic treatment time is within the above range, it is possible not only to sufficiently emulsify the dispersoid by microcapsulating the dispersoid but also to prevent the microcapsule from being destroyed. When the ultrasonic treatment is performed beyond the above range, the microcapsule may be destroyed by the excessive energy, and thereby the dispersion stability of the liquid-liquid dispersion system is deteriorated.

An average particle size of the microcapsulated dispersoid is also not particularly limited; however, it is preferably equal to or less than 3 μm, and it is more preferably equal to or less than 1.5 μm. When the particle size of the microcapsulated dispersoid is within the above range, there is a tendency that the dispersion stability of the dispersoid is further improved. When the particle size of the microcapsulated dispersoid is beyond the above range, there is a tendency that a dispersion system is easily destroyed by sedimentation or coalescence due to the influence of specific gravity or the like.

### 3. USE OF DISPERSION LIQUID

According to the method of manufacturing a dispersion liquid of the embodiment, it is possible to efficiently disperse the dispersoid into the dispersion medium, and the dispersion liquid obtained through this manufacturing method is excellent in the dispersion stability. Accordingly, the dispersion liquid which is obtained through the method of manufacturing a dispersion liquid according to the embodiment can be applied to the following uses, for example.

The dispersion liquid which is obtained through the method of manufacturing a dispersion liquid according to the embodiment can be applied to a coating material, ink, food, a cosmetic, a pharmaceutical, and the like. The dispersion liquid is preferably used for the food, and examples of the food include general foods such as a nutrition drink, nourishing tonic, palatability beverage, and a frozen dessert, and capsule-type dietary supplements. In addition, the dispersion liquid is preferably used for a cosmetic material, and examples of the cosmetic material include skin lotion, beauty essence, milky lotion, cream pack masks, packs, hair care products, fragrances, liquid body cleansers, UV skin care products, deodorant, and oral care products.

### 4. EXAMPLES

Hereinafter, the invention will be described in detail based on Examples; however, the invention is not limited to Examples described below. “Part” and “%” in Examples and Comparative Examples are given on a mass basis unless otherwise indicated.

### 4.1. Configuration of Manufacturing Apparatus of Dispersion Liquid

A manufacturing apparatus a illustrated in FIG. 1 which is described in the first embodiment, and a manufacturing apparatus b illustrated in FIG. 2 which is described in the second embodiment are prepared. The detailed configuration of each of the manufacturing apparatuses is as follows.

### Manufacturing Apparatus a

Crushing treatment mechanism; a desktop-type ultrasonic washing machine, Model No. “W-113” manufactured by Honda Electronics Co., Ltd., Frequency: adjustable in three stages of 28 kHz, 45 kHz, and 100 kHz
Crushing treatment mechanism; a desktop-type ultrasonic washing machine, Model No. “W-357-07HPD” manufactured by Honda Electronics Co., Ltd., Frequency: 740 kHz
Crushing treatment mechanism; a desktop-type ultrasonic washing machine, Model No. “W-357HPD” manufactured by Honda Electronics Co., Ltd., Frequency: 1000 kHz
Liquid plasma treatment mechanism; Electrode material: tungsten, Distance between electrodes: 5 mm, Power: 30 V, AC Frequency: 30 kHz

### Manufacturing Apparatus b

Crushing treatment mechanism; an ultrasonic homogenizer, Model No. “S-250D” manufactured by Branson Ultrasonics Corporation, Frequency: 19.9 kHz, Power (energy): 200 W
Crushing treatment mechanism; an ultrasonic homogenizer, Model No. “SLPe40” manufactured by Branson Ultrasonics Corporation, Frequency: 40 kHz, Power (energy): 150 W
Liquid plasma treatment mechanism; electrode material: tungsten, Distance between electrodes: 5 mm, Power: 30 W, AC Frequency: 30 kHz

### 4.2. Examples 1 to 19 and Comparative Examples 1 to 2

### Preparation of Dispersion Liquid

First, materials indicated in Table 1 and Table 2 were mixed with each other so as to prepare a mixed liquid. Then, each dispersion liquid was prepared by performing the liquid plasma treatment while performing the ultrasonic treatment on the mixed liquid obtained under the conditions indicated in Table 1 and Table 2 by using any one of the above-described manufacturing apparatus.

### Evaluation of Dispersion Stability

The obtained dispersion liquid was moved to a sample bottle, and the sample bottle was tightly sealed, was shaken for 10 seconds, and then was left to stand at room temperature. After 24 hours, the state of the dispersion liquid was visually observed. Evaluation criteria are as follows.

A: A dispersoid contained in the dispersion liquid after being left is almost uniformly dispersed in a continuous manner.

B: A portion of the dispersoid contained in the dispersion liquid after being left is sedimented or separated on the liquid surface; however, when the sample bottle is shaken, the dispersoid is uniformly dispersed again.

C: The dispersoid contained in the dispersion liquid after being left is sedimented or completely separated on the liquid surface, and even when the sample bottle is shaken, the dispersoid is not uniformly dispersed.

### Measurement of Average Particle Size

The volume-based particle size distribution of the dispersion liquid which was left for 24 hours in the above description was calculated by using a particle size distribution measuring device (Product name: “Nanotrac UPA”, manufactured by Nikkiso Co., Ltd.) based on a dynamic light scattering method as principle of measurement, and then a median size which is calculated from the particle size distribution is set to be an average particle size. Evaluation criteria are as follows.

A: The particle size distribution is a single peak, and the median size is equal to or less than 1.5 μm.
B: The particle size distribution is a single peak, and the median size is greater than 1.5 μm and equal to or less than 3 μm.
C: The median size is greater than 3 μm, or the microcapsulation is not performed.

### Result of Evaluation

Conditions for experiments, compositions of the mixed liquid, and evaluation results of Examples 1 to 19, and Comparative Examples 1 to 2 are indicated in Table 1 and Table 2.

TABLE 1

| | | | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 | ple 11 |
| Conditions of ultrasonic | | Configura- | b | b | a | a | a | a | a | b | b | b | b |
| wave generating apparatus | | tion of | | | | | | | | | | | |
| | | apparatus | | | | | | | | | | | |
| | | Frequency | 20 | 40 | 28 | 45 | 100 | 740 | 1000 | 20 | 20 | 20 | 20 |
| | | (kHz) | | | | | | | | | | | |
| | | Treatment | 10 | 10 | 10 | 10 | 10 | 10 | 10 | 0.1 | 1 | 20 | 60 |
| | | time | | | | | | | | | | | |
| | | (minutes) | | | | | | | | | | | |
| Mixed liquid | First solvent | Pure water | 85 | 85 | 85 | 85 | 85 | 85 | 85 | 85 | 85 | 85 | 85 |
| compositions | | (mass %) | | | | | | | | | | | |
| | Second | n-hexane | 10 | 10 | 10 | 10 | 10 | 10 | 10 | 10 | 10 | 10 | 10 |
| | solvent | (mass %) | | | | | | | | | | | |
| | | Toluene | — | — | — | — | — | — | — | — | — | — | — |
| | | (mass %) | | | | | | | | | | | |
| | compound | Acrylic acid | 5 | 5 | 5 | 5 | 5 | 5 | 5 | 5 | 5 | 5 | 5 |
| | having | (mass %) | | | | | | | | | | | |
| | polymerizable | n-octyl | — | — | — | — | — | — | — | — | — | — | — |
| | functional | acrylate | | | | | | | | | | | |
| | group | (mass %) | | | | | | | | | | | |
| | | Bovine | — | — | — | — | — | — | — | — | — | — | — |
| | | serum | | | | | | | | | | | |
| | | albumin | | | | | | | | | | | |
| | | (mass %) | | | | | | | | | | | |
| | | Styrene | — | — | — | — | — | — | — | — | — | — | — |
| | | (mass %) | | | | | | | | | | | |
| | Solid material | Carbon | — | — | — | — | — | — | — | — | — | — | — |
| | | powder | | | | | | | | | | | |
| | | (mass %) | | | | | | | | | | | |

| | | | | | | | | | | | | |
|---|---|---|---|---|---|---|---|---|---|---|---|---|
| Evaluation results | Average | A | A | A | A | A | A | A | B | A | A | B |
| | particle | | | | | | | | | | | |
| | size (nm) | | | | | | | | | | | |
| | Dispersion | A | A | B | B | B | B | B | B | A | A | B |
| | stability | | | | | | | | | | | |

TABLE 2

| | | | | | | | | | | | Compar- | Compar- |
|---|---|---|---|---|---|---|---|---|---|---|---|---|
| | | | | | | | | | | | ative | ative |
| | | | Exam- | Exam- | Exam- | Exam- | Exam- | Exam- | Exam- | Exam- | Exam- | Exam- |
| | | | ple 12 | ple 13 | ple 14 | ple 15 | ple 16 | ple 17 | ple 18 | ple 19 | ple 1 | ple 2 |
| Conditions of ultrasonic | | Configura- | b | b | b | b | b | b | b | b | b | b |
| wave generating apparatus | | tion of | | | | | | | | | | |
| | | apparatus | | | | | | | | | | |
| | | Frequency | 20 | 20 | 20 | 20 | 20 | 20 | 20 | 20 | 20 | 20 |
| | | (kHz) | | | | | | | | | | |
| | | Treatment | 10 | 10 | 10 | 10 | 10 | 10 | 10 | 10 | 10 | 10 |
| | | time | | | | | | | | | | |
| | | (minutes) | | | | | | | | | | |
| Mixed liquid | First solvent | Pure water | 85 | 85 | 80 | 85 | 90 | 65 | 89.95 | 70 | 95 | 90 |
| compositions | | (mass %) | | | | | | | | | | |
| | Second | n-hexane | 10 | 10 | 10 | 10 | 5 | 30 | 10 | 10 | — | 10 |
| | solvent | (mass %) | | | | | | | | | | |
| | | Toluene | — | — | — | — | — | — | — | — | — | — |
| | | (mass %) | | | | | | | | | | |
| | compound | Acrylic acid | — | — | 5 | — | 5 | 5 | 0.05 | 20 | 5 | — |
| | having | (mass %) | | | | | | | | | | |
| | polymerizable | n-octyl | 5 | — | — | — | — | — | — | — | — | — |
| | functional | acrylate | | | | | | | | | | |
| | group | (mass %) | | | | | | | | | | |
| | | Bovine | — | 5 | — | — | — | — | — | — | — | — |
| | | serum | | | | | | | | | | |
| | | albumin | | | | | | | | | | |
| | | (mass %) | | | | | | | | | | |
| | | Styrene | — | — | — | 5 | — | — | — | — | — | — |
| | | (mass %) | | | | | | | | | | |
| | Solid material | Carbon | — | — | 5 | — | — | — | — | — | — | — |
| | | powder | | | | | | | | | | |
| | | (mass %) | | | | | | | | | | |

| Evaluation results | Average | A | A | A | C | A | B | B | B | C | C |
|---|---|---|---|---|---|---|---|---|---|---|---|
| | particle | | | | | | | | | | |
| | size (nm) | | | | | | | | | | |
| | Dispersion | A | A | A | B | A | A | B | B | C | C |
| | stability | | | | | | | | | | |

The Following materials were used as the materials indicated in Table 1 and Table 2.
n-hexane (manufactured by Wako Pure Chemicals Industries, Ltd.)
Toluene (manufactured by Wako Pure Chemicals Industries, Ltd.)
Acrylic acid (manufactured by Wako Pure Chemicals Industries, Ltd.)
n-octyl acrylate (Product name “NOAA”, manufactured by Osaka Organic Chemical Industry Ltd.)
Bovine serum albumin (manufactured by Wako Pure Chemicals Industries, Ltd., 22%)
Styrene (manufactured by Wako Pure Chemicals Industries, Ltd.)
Carbon powder (Product name “Colour Black S170”, manufactured by Evonik Japan Co., Ltd.)

In Examples 1 to 2, each dispersion liquid was prepared by changing conditions of the frequency of the ultrasonic homogenizer with the configuration of the apparatus b. According to the evaluation results of Examples 1 to 2, it was possible to manufacture a microcapsule which capsulates a dispersoid formed of the second solvent, and thus a dispersion liquid which is excellent in the dispersion treatment efficiency and the dispersion stability was obtained.

In Examples 3 to 7, each dispersion liquid was prepared by changing conditions of the frequency of the ultrasonic washing machine with the configuration of the apparatus a. According to evaluation results of Examples 3 to 7, it was possible to manufacture a microcapsule which capsulates a dispersoid formed of the second solvent, but it was found that the dispersion treatment efficiency was slightly deteriorated as compared with a case of using the ultrasonic homogenizer (Example 1 and Example 2).

In Examples 8 to 11, each dispersion liquid was prepared by changing conditions of the ultrasonic treatment time with the configuration of the apparatus b. According to the evaluation results of Examples 8 and 9, the dispersion treatment efficiency was adequate when the ultrasonic treatment time was 0.1 minutes; however, when the ultrasonic treatment time was changed to be equal to or longer than 1 minute, the dispersion treatment efficiency was further improved, and thereby it was possible to obtain the dispersion liquid which is excellent in the dispersion stability. In addition, according to the evaluation results of Examples 10 and 11, it was found that when the ultrasonic treatment time was set to be 60 minutes, a phenomenon in which the formed microcapsule is destroyed by the ultrasonic waves and thus the dispersion treatment efficiency was slightly deteriorated as compared with the cases of Example 1 and Example 2.

In Examples 12 to 19, each dispersion liquid was prepared by changing the compositions of the mixed liquid with the configuration of the apparatus b. According to the evaluation results of Examples 12 and 13, even when n-octyl acrylate or bovine serum albumin was used as the compound having a polymerizable functional group, the dispersion treatment efficiency was excellent, and thereby it was possible to obtain the dispersion liquid which is excellent in the dispersion stability. According to the evaluation result of Example 14, when a carbon powder was added as a solid material, it was possible to obtain a microcapsule which capsulates a solution of the n-hexane into which the carbon powder was dissolved, and thereby it was possible to obtain the dispersion liquid which is excellent in the dispersion treatment efficiency and the dispersion stability. According to the evaluation result of Example 15, styrene was used as the compound having a polymerizable functional group, but since the styrene is deficient in amphiphilicity, not only the microcapsule but also an independent polymer particle was also generated. As a result, it was found that the average particle size is slightly large and the dispersion stability was slightly deteriorated compared with the cases of in Example 1 and Example 2.

In Examples 16 and 17, each dispersion liquid was prepared by using the mixed liquid which is obtained by changing the content ratio between the first solvent and the second solvent. According to the evaluation result of Example 17, it was found that when the content of the second solvent which was the dispersoid is 30 mass %, it was likely to be a state of over-dispersion in which dispersoids collide with each other, and thus the dispersion state was excellent; however, the average particle size was slightly large compared with the cases of Example 1 and Example 2.

In Examples 18 and 19, each dispersion liquid was prepared by using the mixed liquid which is obtained by changing the content ratio of the compound having a polymerizable functional group. According to the evaluation result of Examples 18 and 19, it was found that even when the content of the material for the compound having a polymerizable functional group was excessively large or small, the particle size of the formed microcapsule was likely to be larger, and the dispersion stability was slightly deteriorated compared with the cases of in Example 1 and Example 2.

In Comparative Example 1, a dispersion liquid was prepared by using a mixed liquid which does not contain the second solvent with the configuration of the apparatus b. According to the evaluation result of Comparative Example 1, even when the second solvent which is the dispersoid did not exist, a microcapsule which set the cavitation (bubbles) as a core was obtained; however, the cavitation was floated on the liquid surface, and thus it was difficult to perform the liquid plasma treatment. For this reason, it was found that the dispersion treatment efficiency was deteriorated, the average particle size of the dispersoid became larger, and the dispersion stability was also deteriorated.

In Comparative Example 2, a dispersion liquid was prepared by using a mixed liquid which does not contain the compound having a polymerizable functional group with the configuration of the apparatus b. According to the evaluation result of Comparative Example 2, it was found that since a film-forming material did not exist, the microcapsulation was not performed, and even when the liquid plasma treatment was performed on the dispersoid which is formed of the second solvent, the interface has fluidity, and thus the average particle size of the dispersoid became larger over time, and as a result, the dispersion stability was deteriorated.

The present invention is not limited to the above embodiments, and various modifications are possible. For example, the invention includes configurations substantially the same as the configurations described in the embodiments (for example, a configuration having the same function, method, and result, or a configuration having the same purpose and effect). The invention also includes a configuration that replaces non-essential parts of the configuration described in the embodiments. The invention also includes a configuration that can exhibit the same action and effect or a configuration that can achieve the same purpose as those of the configuration described in the embodiment. The invention also includes a configuration obtained by adding a known technique to the configuration described in the embodiment.

The entire disclosure of Japanese Patent Application No. 2015-33591, filed Feb. 24, 2015 is expressly incorporated by reference herein.

What is claimed is:

1. A method of manufacturing a dispersion liquid, comprising:
preparing a mixed liquid which contains a first solvent, a second solvent having solubility which is equal to or less than 1% with respect to the first solvent, and a compound having a polymerizable functional group; and
microcapsulating and dispersing the first solvent or the second solvent by performing liquid plasma treatment on the mixed liquid while applying ultrasonic waves to the mixed liquid by using an ultrasonic wave generating apparatus.

2. The method of manufacturing a dispersion liquid according to claim 1,
wherein an oscillation frequency of the ultrasonic wave generating apparatus is in a range of 10 kHz to 1000 kHz.

3. The method of manufacturing a dispersion liquid according to claim 1,
wherein the polymerizable functional group is at least one selected from the group consisting of a (meth)acryloyl group, a vinyl group, a vinyl ether group, and a mercapto group.

4. The method of manufacturing a dispersion liquid according to claim 1,
wherein the compound having a polymerizable functional group is a material having amphiphilicity.

5. The method of manufacturing a dispersion liquid according to claim 1,
wherein the mixed liquid further includes a solid material which is dissolved in any one of the first solvent and the second solvent.

6. The method of manufacturing a dispersion liquid according to claim 1,
wherein a content of the compound having a polymerizable functional group in the mixed liquid is in a range of 0.01 mass % to 50 mass %.

7. A manufacturing apparatus of a dispersion liquid, comprising:
a storage tank into which a mixed liquid containing a first solvent, a second solvent having solubility which is equal to or less than 1% with respect to the first solvent, and a compound having a polymerizable functional group is put;
an ultrasonic wave generating mechanism that applies ultrasonic waves to the mixed liquid which is put into the storage tank; and
a liquid plasma treatment mechanism that performs plasma treatment on the mixed liquid which is put into the storage tank,
wherein a microcapsule which is obtained by the ultrasonic irradiation in the mixed liquid is dispersed in the mixed liquid by performing the liquid plasma treatment with respect to the microcapsule by using the liquid plasma treatment mechanism.
